(19) United States
(12) Patent Application Publication
(10) Pub. No.: US 2015/0000439 A1
(43) Pub. Date: Jan. 1, 2015

(54) Method for Operating a Double Clutch Transmission

(71) Applicant: ZF Friedrichshafen AG, Friedrichshafen (DE)

(72) Inventor: Axel Rohm, Schonungen (DE)

(21) Appl. No.: 14/314,572

(22) Filed: Jun. 25, 2014

(30) Foreign Application Priority Data
Jun. 26, 2013 (DE) 10 2013 212 152.0

(51) Int. Cl. F16H 3/087

(52) U.S. Cl. CPC F16H 3/087
USPC 74/330

(57) ABSTRACT

A method for the operation of a dual-clutch transmission wherein, through a clutch of a dual-clutch device, sub-transmissions are able to be switched on in the power flux of the dual-clutch transmission or are able to be switched off from the power flux. In the sub-transmissions, two different transmission ratios are able to be engaged or disengaged through the actuation of shifting elements. In the operation of the dual-clutch transmission, one of the sub-transmissions is switched on, while the other sub-transmission is switched off. If the transmission ratio in the switched-on sub-transmission is engaged, all transmission ratios in the switched-off sub-transmission are simultaneously disengaged through the shifting elements, as long as there is no request for a change of transmission ratio in the dual-clutch transmission.

### FIELD OF THE INVENTION

The invention relates to a method for operating a dual-clutch transmission.

### BACKGROUND

Dual-clutch transmissions known in practice feature, in each case through a clutch of a dual-clutch device, sub-transmissions that are able to be switched on in the power flux of the dual-clutch transmission or are able to be switched off from the power flux, in which, in each case, at least two different transmission ratios are able to be engaged or disengaged through the actuation of shifting elements. In the operation of the dual-clutch transmission, essentially, one of the sub-transmissions is switched on, while the other sub-transmission is switched off, whereas the transmission ratio currently provided in the dual-clutch transmission is engaged in the switched-on sub-transmission, while, in the switched-off sub-transmission, an additional transmission ratio is engaged, which in the dual-clutch transmission in the future is to be engaged with a high probability in the dual-clutch transmission.

Typically, shifting elements, through which transmission ratios are engaged or disengaged in the sub-transmission, are arranged on a main transmission shaft and/or on a countershaft, and are carried out as space-saving and cost-saving positive-locking, claw-shifting elements or as so-called synchronizations. In order to engage a transmission ratio in the sub-transmission, at least one or several such shifting elements are to be correspondingly actuated. With the transmission ratio engaged in the sub-transmission, a rotational speed of a countershaft of the sub-transmission is determined from an output transmission ratio and a rotational speed of a transmission output shaft. In the power path through the switched-on sub-transmission, a dual-clutch transmission is operated synchronously and essentially without recording a performance loss and the entire turning moment between the drive unit and the output of a vehicle drive train carried out with the dual-clutch transmission is essentially transferred through this power path. By contrast, through the switched-off sub-transmission, due to the allocated open clutch of the dual-clutch device, essentially no turning moment is transferred.

However, drag moments arise in the open clutch of the dual-clutch device allocated to the switched-off sub-transmission, which represent a power loss and impair the efficiency factor of a dual-clutch transmission in a scope that is not negligible, and thus unnecessarily increase the consumption of the drive unit, whereas such drag moments, in the clutches of the dual-clutch device, through the natural coupling of the two sub-transmissions, have a braking effect on the drive. This gives rise to the overall drag losses of a dual-clutch transmission resulting from the equilibrium between the transmission drag moments resulting in bearings and from gearing losses, with the corresponding transmission ratio influences.

### SUMMARY OF THE INVENTION

Therefore, this invention is subject to the task of providing a method, by means of which a dual-clutch transmission is able to be operated with a high efficiency factor. Additional objects and advantages of the invention will be set forth in part in the following description, or may be obvious from the description, or may be learned through practice of the invention.

In accordance with the invention, the tasks are solved with a method with the characteristics of the appended claims.

With the method in accordance with the invention for the operation of a double-clutch transmission with, in each case through a clutch of a dual-clutch device, sub-transmissions that are able to be switched on in the power flux of the dual-clutch transmission or are able to be switched off from the power flux, at least two different transmission ratios are able to be engaged or disengaged through the actuation of shifting elements in each sub-transmission, whereas, in the operation of the dual-clutch transmission, essentially one of the sub-transmissions is switched on, while the other sub-transmission is switched off.

In accordance with the invention, if the transmission ratio in the switched-on sub-transmission is engaged in the switched-on sub-transmission, all transmission ratios in the switched-off sub-transmission are simultaneously disengaged through the shifting elements, as long as there is no request for a change of transmission ratio in the dual-clutch transmission.

Based on the approach in accordance with the invention, drag losses in a switched-off sub-transmission are reduced, with a low control and regulating effort, since, through the disengagement of all transmission ratios in the switched-off sub-transmission, through the shifting elements, gear wheels that are able to be switched on are loosely meshed with one another, and the drag moment arising in the open clutch of the dual-clutch device, which is allocated to the switched-off sub-transmission, can be supported only to the extent of the idler gear/storage turning moments. Based on experience, idler gear/storage turning moments are very low, and/or much lower than the drag moments arising in a wet-running multi-disk clutch. For this reason, the drag moments impairing the efficiency factor of a dual-clutch transmission in the operation of the dual-clutch transmission are, with little effort, able to be reduced to a minimum by means of the approach in accordance with the invention. In addition, depending on the respective transmission ratio relationships, the bearing drag moments feature a lower level, as long as a transmission ratio, which is not a gear reduction or an overdrive gear ratio, is engaged in the switched-on sub-transmission.

Thus, the drag moment arising in the switched-off sub-transmission of a dual-clutch transmission operated in accordance with experience is lower than the clutch drag moment arising in the open clutch allocated to the switched-off sub-transmission. This lead to the fact that a transmission input shaft of the switched-off sub-transmission is led in the direction of a rotational speed of a drive unit connected to the transmission input shaft of the dual-clutch transmission, until the drag moments offset each other. Thereby, the power flow in the non-active power train of the dual-clutch transmission is reduced significantly. For this reason, the losses are further reducible through the disengagement of an output transmission ratio level.

This also means that the total losses in the dual-clutch transmission through the approach in accordance with the invention are smaller when compared to a conventional mode of operation of a dual-clutch transmission, with which, in the switched-off sub-transmission, a transmission ratio that is possibly to be engaged in the future is engaged or remains engaged, regardless of whether the transmission ratio engaged in the switched-off sub-transmission concerns a lower or a higher driving stage than the transmission ratio engaged in the switched-on sub-transmission.

If, after a delivery of a turning moment between a sub-transmission to be switched off and a sub-transmission to be switched on carried out by a change of transmission ratio in the area of a dual-clutch transmission, starting from a lower gear in the direction of a higher gear in the switched-off sub-transmission, the lower gear is engaged, due to the reactive power flows in the switched-on sub-transmission, higher losses arise compared to when there is a pre-selection of a higher gear in the switched-off sub-transmission.

Thus, the disengagement of the lower gear in the switched-off sub-transmission, preferably directly after the transfer of the turning moment in the dual-clutch transmission from the sub-transmission to be switched off in the direction of the sub-transmission to be switched on through the dual-clutch device and/or its clutches, represents a simple and effective measure for improving the efficiency factor of a dual-clutch transmission.

With one advantageous variant of the method in accordance with the invention, the transfer capacity of the clutch of the dual-clutch device allocated to the switched-off sub-transmission, for the transmission ratios disengaged in the switched-off sub-transmission, is at least approximately equal to zero. Thus, if there is a request for the engagement of a transmission ratio in the switched-off sub-transmission, the clutch allocated to the switched-off sub-transmission is fully open, and the transmission ratio to be engaged in the switched-off sub-transmission is essentially able to be engaged in the load-free operating state of the shifting elements of the switched-off sub-transmission.

With a further advantageous variant of the method in accordance with the invention, the transfer capacity of the clutch of the dual-clutch device allocated to the switched-off sub-transmission, for the transmission ratios disengaged in the switched-off sub-transmission, is adjusted to a value at which the clutch is operated in a state that is at least approximately slip-free. Thus, in a simple manner, drag moments arising in the clutch are avoided, and a dual-clutch transmission is operable with low power losses. This results from the fact that, upon the slip-free operation of the clutch allocated to the switched-off sub-transmission, differential rotational speeds are, between the transmission input shaft of the dual-clutch transmission and the transmission output shaft in the areas of the shifting elements provided for the engagement and disengagement of the transmission ratios in the switched-off sub-transmission, which are preferably carried out as positive-locking shifting elements, such as synchronizations or the like, are displaced, in which the drag losses are lower than they are in multi-disk shifting elements and/or clutches of dual-clutch devices.

With an additional advantageous variant of the invention method, if there is a request to carry out a change of transmission ratio in the dual-clutch transmission, starting from an actual transmission ratio engaged in the current switched-on sub-transmission in the direction of a target transmission ratio, which is able to be presented in the switched-off sub-transmission, the requested target transmission ratio is engaged in the switched-off sub-transmission, and subsequently the switched-on sub-transmission is switched off by opening the allocated clutch of the dual-clutch device, while the switched-off sub-transmission is switched on by closing the allocated clutch of the dual-clutch device, whereas the actual transmission ratio in the sub-transmission, which represents the switched-off sub-transmission after the change of transmission ratio, disengages after the change of transmission ratio, preferably immediately. Thereby, the engagement of the requested target transmission ratio in the switched-off sub-transmission preferably takes place as chronologically coordinated as possible, such that, if there is a request to carry out a change of transmission ratio, this is carried out only briefly prior to the fading of the turning moment.

In order to minimize shifting times in a dual-clutch transmission, and to be able to operate a dual-clutch transmission with a desired high level of spontaneity with a further advantageous variant of the method in accordance with the invention, the actual transmission ratio engaged in the switched-off sub-transmission after the change of transmission ratio remains engaged until the probability for a further change of transmission ratio in the dual-clutch transmission, starting from the target transmission ratio of the currently switched-on sub-transmission in the direction of the actual transmission ratio of the currently switched-off sub-transmission, is less than a threshold value.

With a further advantageous variant of the method in accordance with the invention, in the switched-off sub-transmission, all of the transmission ratios are disengaged until there is a request for a further change of transmission ratio in the dual-clutch transmission, starting from an actual transmission ratio of the currently switched-on sub-transmission currently engaged in the dual-clutch transmission in the direction of a requested target transmission ratio of the currently switched-off sub-transmission. Thereby, power losses in a dual-clutch transmission are reduced to a desired extent, beyond an operating range that is as large as possible, and a vehicle carried out with a dual-clutch transmission operated in accordance with the invention is able to be operated as efficiently as possible.

Both the characteristics specified in the patent claims and the characteristics specified in the subsequent embodiments of the subject matter under the invention are, by themselves alone or in any combination with one another, suitable for providing additional forms for the subject matter under the invention. In terms of the additional forms of the object under the invention, the particular combinations of characteristics do not represent a limitation; rather, they are essentially solely of an exemplary nature.

### BRIEF DESCRIPTION OF THE DRAWINGS

Additional advantages and advantageous embodiments of the invention arise from the patent claims and the embodiments described with reference to the drawings in terms of principle.

The following is shown:

FIG. 1 a transmission diagram of a dual-clutch transmission with a switched-on sub-transmission and a switched-off sub-transmission, whereas, in the area of the switched-off sub-transmission, a gear that is smaller than that in the switched-on sub-transmission is engaged;

FIG. 2 a representation corresponding to FIG. 1, whereas, in the switched-on sub-transmission, a gear smaller than that in the switched-off sub-transmission is engaged;

FIG. 3 a representation corresponding to FIG. 1, whereas, in the switched-on sub-transmission, one transmission ratio is engaged, and, in the switched-off sub-transmission, all transmission ratios are disengaged;

FIG. 4 several sequences of various operating sizes of the dual-clutch transmission in accordance with FIG. 1 for the period t, which occur during a conventional mode of operation of the dual-clutch transmission; and

FIG. 5 sequences of various operating sizes of the dual-clutch transmission in accordance with FIG. 1, which arise during a mode of operation of the dual-clutch transmission in accordance with the invention.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

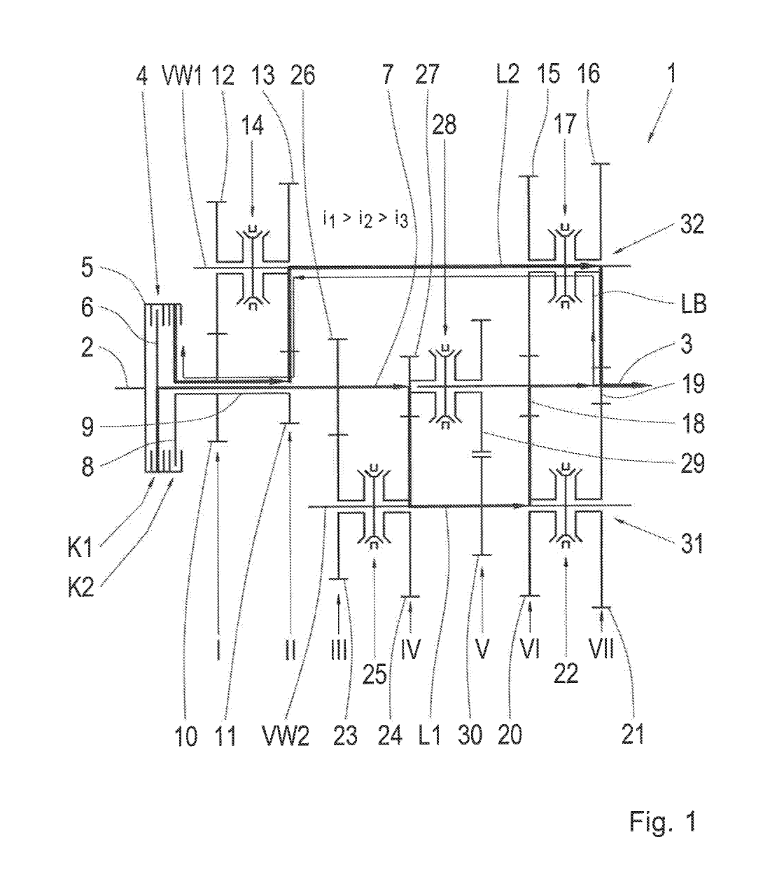

FIG. 1 shows a transmission diagram of a dual-clutch transmission 1 with a transmission input shaft 2 and a transmission output shaft 3. In a manner that is per se known, the transmission input shaft 2 is connected in a torque-proof manner to a dual-clutch device 4 in a common outer multi-disk carrier 5 of two clutches K1 and K2 of the dual-clutch device 4. An inner multi-disk carrier 6 of the clutch K1 is coupled in a torque-proof manner to a first transmission input shaft 7 of the dual-clutch transmission 1, and an inner multi-disk carrier 8 of the clutch K2 is coupled in a torque-proof manner to a second transmission input shaft 9 of the dual-clutch transmission 1, which in the present case is carried out as a hollow shaft, and is arranged coaxially to the first transmission input shaft 7.

In the present case, the second transmission input shaft 9 is carried out with two fixed gears 10, 11, which, on a first countershaft VW1 of the dual-clutch transmission 1, mesh with rotatably arranged idler gears 12, 13. Through a shifting element 14 carried out as a so-called double-shifting element, the idler gears 12 and 13 are alternately able to be brought into operative connection in a torque-proof manner to the first countershaft VW1. Furthermore, two additional idler gears 15 and 16 are rotatably arranged on the first countershaft VW1. Through an additional shifting element 17, which is likewise designed as a space-saving double-shifting element 17, such idler gears are alternately able to be coupled in a torque-proof manner to the first countershaft VW1. In each case, the additional idler gears 15 and 16 mesh with fixed gears 18, 19 of the transmission output shaft 3, which additionally engage with idler gears 20, 21 rotatably arranged on a second countershaft VW2. In turn, the idler gears 20 and 21 are, through an additional shifting element 22 or a double-shifting element, as the case may be, alternately able to be connected in a torque-proof manner to the second countershaft VW2. Two additional idler gears 23 and 24 are, through a further double-shifting element or shifting element 25, as the case may be, alternately able to be brought into operative connection in a torque-proof manner to a second countershaft VW2, for transferring a turning moment. The idler gears 23 and 24 mesh with fixed gears 26 and 27 of the first transmission input shaft 7.

In the present case, the first transmission input shaft 7 and the transmission output shaft 3 are arranged coaxially to each other, and are able to be connected to each other in a torque-proof manner in a first shift position of an additional double-shifting element 28. In a second shift position of the double-shifting element 28, the first transmission input shaft 7 and the transmission output shaft 3 are separated from each other, and an idler gear 29 rotatably arranged on the transmission output shaft 3 is then connected in a torque-proof manner to the transmission output shaft 3, when then engages with a fixed gear 30 of the second countershaft VW2. In a third shift position of the double-shifting element 28, neither the first transmission input shaft 7 and the transmission output shaft 3 are connected to each other in a torque-proof manner, nor is the idler gear coupled in a torque-proof manner to the transmission output shaft 3, such that the third shift position of the double-shifting element 28 represents a so-called neutral position.

In the present case, the dual-clutch transmission 1 is carried out with seven gear levels I to VII and two sub-transmissions 31 and 32, whereas, in a closed operating state of the clutch K1, the first sub-transmission 31 is switched on in the power flux of the dual-clutch transmission 1 while, in a closed operating state of the second clutch K2 of the dual-clutch device 4, the second sub-transmission 32 is found in the power flow of the dual-clutch transmission 1.

In the dual-clutch transmission 1, multiple transmission ratios for forward motion are presentable, whereas, for this purpose, the double-shifting elements 14, 17, 22, 25 and 28 are each to be correspondingly actuated. In order to be able to, in the dual-clutch transmission 1 through the dual-clutch device 4, carry out shifts without any interruption of the pulling force, if there is a requested change of transmission ratio in the dual-clutch transmission 1, starting from an actual transmission ratio engaged in the sub-transmission 31 or the sub-transmission 32 in the direction of a target transmission ratio that is able to be presented in the currently switched-off sub-transmission 32 or 31, and for the target transmission ratio engaged in the currently switched-off sub-transmission 32 or 31, the clutch K1 or K2, allocated to the switched-on sub-transmission 31 or 32 and found in the closed operating state, is transferred into an open operating state, while the clutch K2 or K1, allocated to the currently switched-off sub-transmission 32 or 31 and found in the open operating state, is transferred into its closed operating state during a so-called overlapping shift.

If, in the second sub-transmission 32 of the dual-clutch transmission 1, the idler gear 13 and the idler gear 16 are connected through the double-shifting elements 14 and 17 to the first countershaft VW1, and the clutch K2 is in a closed operating state, while the first clutch K1 is fully open, a turning moment applied in the transmission input shaft 2 is led through the common outer multi-disk carrier 5, the inner multi-disk carrier 8, the second transmission input shaft 9, the fixed gear 11, the idler gear 13, the first countershaft VW1, the idler gear 16 and the fixed gear 19 meshing with it, to the transmission output shaft 3, which represents a power path L2 of the second sub-transmission 32 in FIG. 1. In this operating state of the dual-clutch transmission 1, a second transmission ratio is engaged in the second sub-transmission 32, which is smaller than that of a first transmission ratio, which is able to be presented in the first sub-transmission 31 and forms a power path L1. Thereby, the first transmission ratio is engaged in the first sub-transmission 31 and thus in the dual-clutch transmission 1, if the idler gears 24 and 20 are connected in a torque-proof manner through the double-shifting elements 25 and 22 to the second countershaft VW2. In addition, a third transmission ratio is engaged in the dual-clutch transmission 1 and/or in the first sub-transmission 31, if, for the idler gear 20 connected in a torque-proof manner to the second countershaft VW2, instead of the idler gear 24, the idler gear 23 is coupled through the double-shifting element 25 to the second countershaft VW2, whereas the third transmission ratio is smaller than the second transmission ratio and is also smaller than the first transmission ratio, and a third gear ratio of the dual-clutch transmission 1 is presented.

With the second transmission ratio engaged in the second sub-transmission 32 and a closed second clutch K2, a turning moment applied in the transmission input shaft 2 is led through the clutch K2 and the power path L2, correspondingly in the direction of the transmission output shaft 3 through the dual-clutch transmission 1. If, at the same time, the first transmission ratio is engaged in the first sub-transmission 31 and the first clutch K1 is fully open, there is a differential rotational speed in the clutch K1 between the common outer multi-disk carrier 5 and the inner multi-disk carrier 6. In the open clutch K1, which, just like the clutch K2, is designed as a multi-disk clutch, a drag moment arises (as is generally known), which is why a part of the turning moment applied in the transmission input shaft 2 is led through the power path L1 and/or through the clutch K1, the first transmission input shaft 7, the fixed gear 26, the switched-on idler gear 24, the second countershaft VW2, the likewise switched-on idler gear 20 and the fixed gear 18 meshing with this, to the transmission output shaft 3. A part of the turning moment led through the power flow L1 is led back by the transmission output shaft 3 along the power path L2 in the direction of the transmission input shaft 2, as a so-called reactive power flow LB. The return power flow LB derives from the fact that, in the switched-off first sub-transmission 31, a transmission ratio higher than that in the switched-on second sub-transmission 32 is engaged.

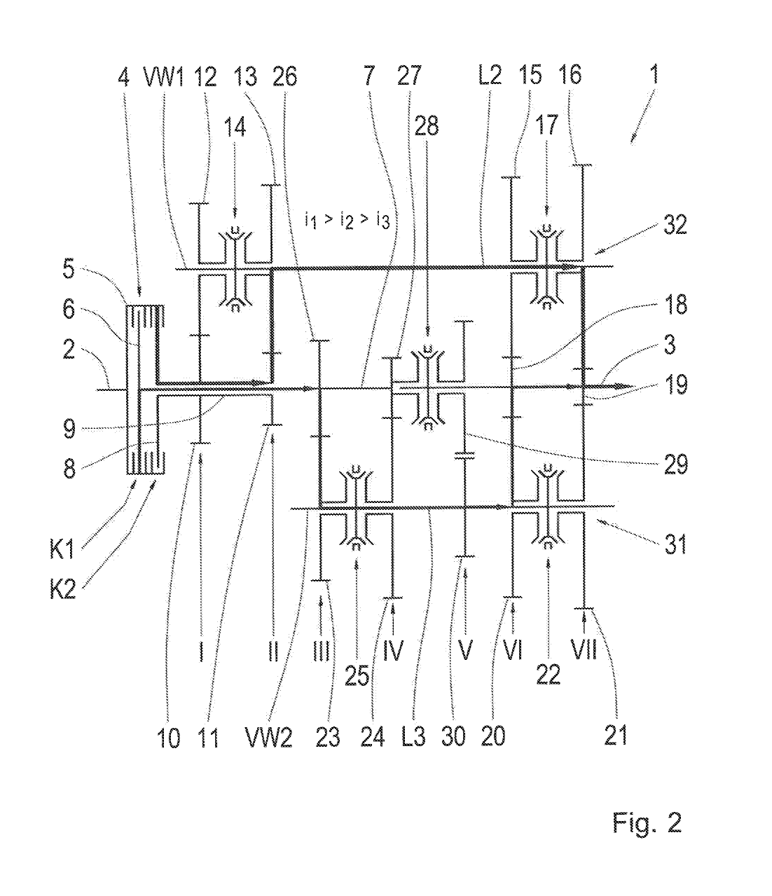

FIG. 2 likewise shows the gear diagram of the dual-clutch transmission 1 in accordance with FIG. 1, in which the second transmission ratio is in turn engaged in the second sub-transmission 32, which is switched on through the clutch K2 in the power flux of the dual-clutch transmission 1. At the same time, with an open first clutch K1, the first sub-transmission 31 represents the switched-off sub-transmission of the dual-clutch transmission 1. A turning moment applied in the transmission input shaft 2 is essentially led in turn through the power flow L2 in the direction of the transmission output shaft 3. However, in the switched-off sub-transmission 31, the third transmission ratio is engaged and the first transmission ratio is disengaged.

Since, in the fully open operating state, the first clutch K1 is operated in a slipping manner, drag moments in turn arise in the clutch K1. For this reason, a small part of the turning moment applied in the transmission input shaft 2 is in turn further led by means of a third power path L3 through the dual-clutch transmission 1 in the direction of the transmission output shaft 3. The third path L3 differs from the power path L1 only in that the turning moment is transferred from the transmission input shaft 2, to the common outer multi-disk carrier 5, to the inner multi-disk carrier 6 and the first transmission input shaft 7, instead of through the fixed gear 27 and the idler gear 24, from the fixed gear 26 to the idler gear 23, and from there to the second countershaft VW2. Subsequently, the turning moment led through the switched-off first sub-transmission 31 is transferred, identically to the power flow L1, from the idler gear 20 to the fixed gear 18, and thus in turn to the transmission output shaft 3.

Since, in the switched-off first sub-transmission 31, a transmission that is smaller than that in the switched-on sub-transmission 32 is engaged, no reactive power flows into the dual-clutch transmission 1, whereby the efficiency factor of the dual-clutch transmission 1 is larger than that for the operating state of the dual-clutch transmission 1 underlying the representation in accordance with FIG. 1.

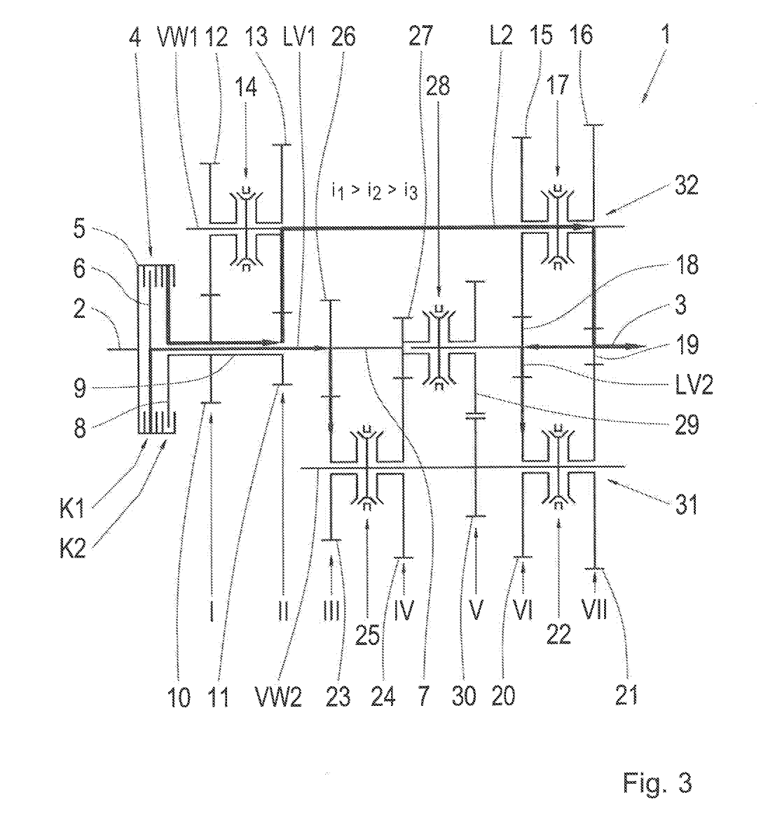

During a sequence of the operating state of the dual-clutch transmission 1 underlying the representation in accordance with FIG. 3, the second transmission ratio is in turn engaged in the switched-on second sub-transmission 32, while, in the switched-off first sub-transmission 31, all transmission ratios are disengaged through the opening of the double-shifting elements 25 and 22. In addition, the transfer capacity of the first clutch K1 is set at a value at which the K1 clutch is operated in a state that is slip-free. Thus, in the clutch K1, no differential rotational speed generating a drag moment is available. However, if there is a differential rotational speed in the area between the idler gear 23 driven by the fixed gear 26 and the second countershaft VW2, it essentially stops. In addition, the idler gear 20 driven by the fixed gear 18, whereby there is also a rotational speed difference in the double-shifting element 22. The rotational speed differences last described in the double-shifting elements 25 and 22 lead to power loss flows LV1 and LV2, which, due to the smaller friction surfaces of the double-shifting elements 25 and 22, compared to the clutch K1, that are substantially smaller than the drag moments arising with an open clutch K1.

Thus, power losses for the first sub-transmission 32 switched on in the dual-clutch transmission 1, which impair the efficiency factor of the dual-clutch transmission 1, are at their lowest if, for the second transmission ratio in the switched-off sub-transmission 31 engaged in the switched-on second sub-transmission 32, all transmission ratios are disengaged, and the clutch K1 allocated to the switched-off first sub-transmission 31 is essentially operated in a state that is slip-free.

The power losses in the double-clutch transmission 1 are, compared to the conventional mode of operation of the dual-clutch transmission 1, even smaller if all transmission ratios in the switched-off first sub-transmission 31 are disengaged, and the clutch K1 allocated to the switched-off first sub-transmission 31 is operated in a slipping state.

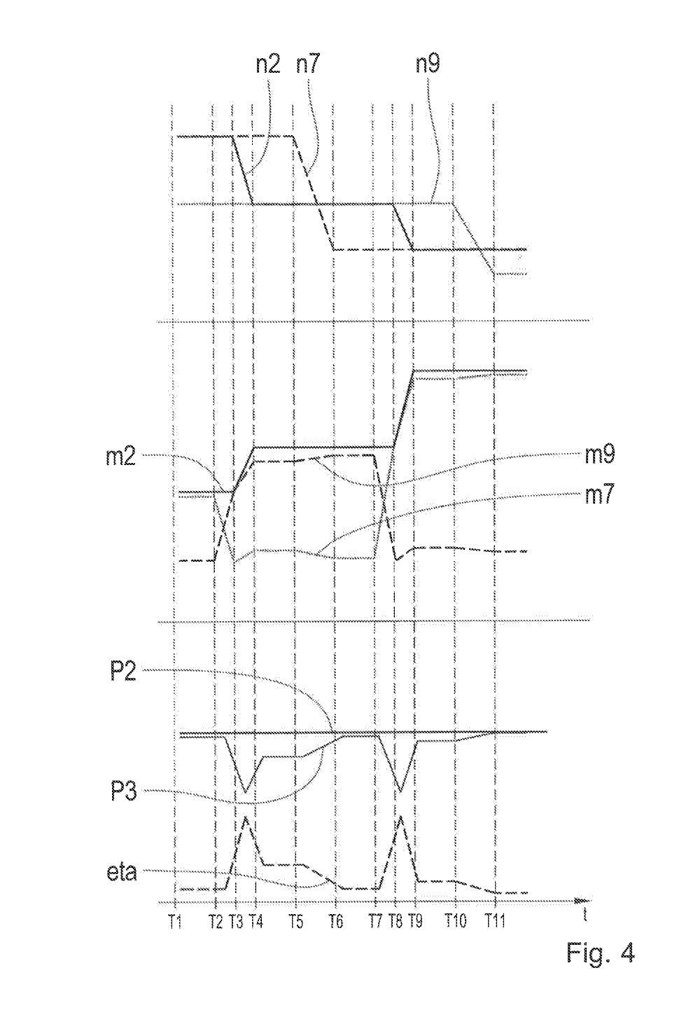

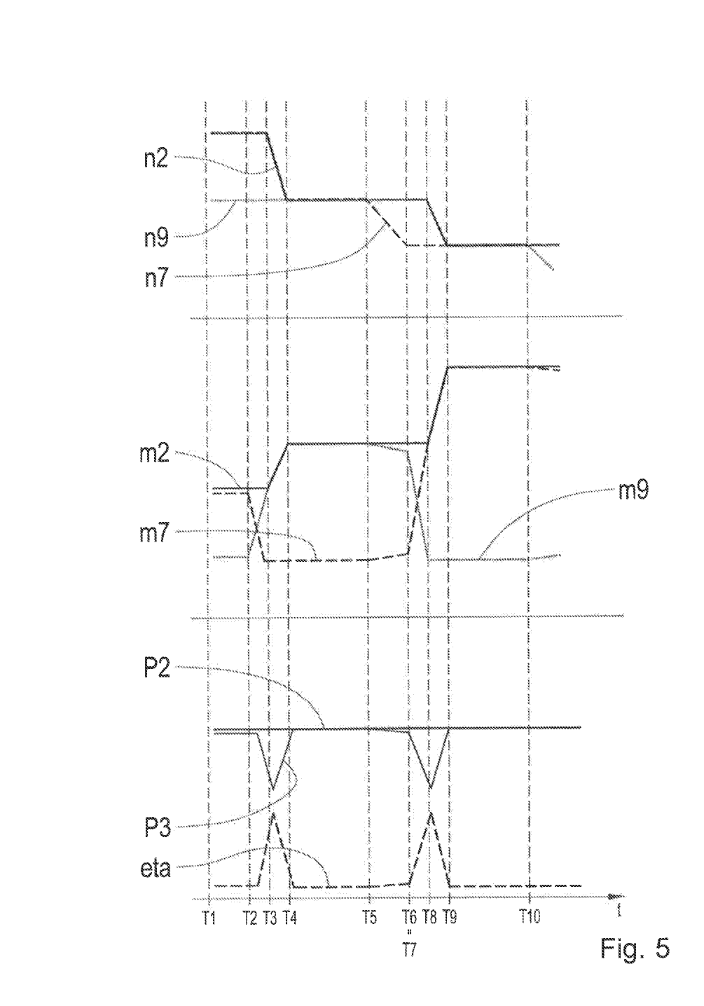

The reduction of the power losses in the dual-clutch transmission 1 achieved based on the mode of operation of the dual-clutch transmission 1 described above is further described below on the basis of the presentations under FIG. 4 and FIG. 5.

FIG. 4 shows several sequences of various operating states of the dual-clutch transmission 1 in a conventional mode of operation of the dual-clutch transmission 1, while the sequences of the operating states shown in FIG. 5 occur upon the use of the approach in accordance with the invention with little effort.

In FIG. 4, in addition to a sequence of a rotational speed n2 of the transmission input shaft 2 of the dual-clutch transmission 1, a sequence of a rotational speed n7 of the first transmission input shaft 7 for the period t is shown. In addition, a sequence of a rotational speed n9 of the second transmission input shaft 9 of the dual-clutch transmission 1 is shown. Under the aforementioned rotational speed sequences n2, n7 and n9, a sequence of a turning moment m2 applied in the transmission input shaft 2, and sequences of turning moments m7 or m9, as the case may be, applied in the first transmission input shaft 7 or the second transmission input shaft 9, as the case may be, are shown. The latter arises depending on a current operating state of the dual-clutch device 4 and the transmission ratios applied for the period t in the sub-transmissions 31 and 32. In turn, below the turning moment sequences m2, m7 and m9, a sequence of a power output P2 led through the transmission input shaft 2 and a sequence of a power output P3 further led through the transmission output shaft 3, along with a sequence of efficiency factor eta of the dual-clutch transmission 1, corresponding to the power outputs P2 and P3, for the period t, are shown, whereas the power output sequences P2 and P3 and the sequence of efficiency factor eta correspond to the rotational speed sequences n2, n7 and n9 and the turning moment sequences m2, m7 and m9. This gives rise in particular to the rotational speed sequences n2, n7 and n9 and the associated rotational speed sequences m2, m7 and m9 during the changes of transmission ratio in the dual-clutch transmission 1, starting from the first transmission ratio in the direction of the second transmission ratio, and a subsequent change of transmission ratio in the dual-clutch transmission 1, starting from the second transmission ratio in the direction of the third transmission ratio.

At a point in time T1, the first transmission ratio is engaged in the dual-clutch transmission 1 and, due to the fully closed first clutch K1, the first sub-transmission 31 is switched on in the power flux, while, due to the fully open second clutch K2, the second sub-transmission 32 is switched off from the power flux of the dual-clutch transmission 1. In addition, the second transmission ratio is already engaged in the second sub-transmission 32. Due to the operating state of the dual-clutch transmission 1 present at the point in time T1, the rotational speed n2 of the transmission input shaft 2 corresponds to the rotational speed n7 of the first transmission input shaft 7, while the rotational speed n9 of the second transmission input shaft 9 corresponds to the synchronous speed, which arises in the dual-clutch transmission 1 for the engaged second transmission ratio in the sub-transmission 32 with the currently present rotational speed of the transmission output shaft 3.

Furthermore, at a point in time T2, due to the request for conducting a change of transmission ratio in the dual-clutch transmission 1, starting from the first transmission ratio in the direction of the second transmission ratio, the transfer capacity of the clutch K1 is reduced, and at the same time the transfer capacity of the second clutch K2 is increased. For this reason, the sequence of the turning moment m7 led through the first transmission input shaft 7 drops off, while the sequence of the turning moment m9 led through the second transmission input shaft 9 rises.

Due to the increasing load transfer from the first clutch K1 in the direction of the second clutch K2, the rotational speed n2 of the transmission input shaft 2 is led from the level of the rotational speed n7 of the first transmission input shaft 7 from the point in time T3 in the direction of the rotational speed n9 of the second transmission input shaft 9, whereas the rotational speed n2 of the transmission input shaft 2 at the point in time T4 corresponds to rotational speed n9 of the second transmission input shaft 9, at which the change of transmission ratio is essentially finished. During the change of transmission ratio, the power output P3 made available in the transmission output shaft 3 decreases and, due to the friction losses that arise in the dual-clutch device 4 during the change of transmission ratio, the efficiency factor eta of the dual-clutch transmission 1 drops in the manner presented in FIG. 4, whereas the efficiency factor eta has its minimum between the points in time T3 and T4. In first sub-transmission 31 switched off at the point in time T4, the first transmission ratio is still engaged, and the drag moments described above arise in the clutch K1, which is now open. In addition, reactive power flows into the dual-clutch transmission 1, which is why the efficiency factor eta remains at a constant level until a point in time T5. At the point in time T5, a request for engaging the third transmission ratio in the switched-off first sub-transmission 31 is generated by a superordinate driving strategy. For this reason, from the point in time T5, the rotational speed n7 of the first transmission input shaft 7 drops from the level of the synchronous speed equivalent to the first transmission ratio in the direction of the rotational speed level, which is equivalent to the synchronous speed that arises for the third transmission ratio engaged in the first sub-transmission 31.

The disengagement of the first transmission ratio and the engagement of the third transmission ratio in switched-off sub-transmission 31 leads to the fact that the third power path L2 more specifically described in FIG. 2, in addition to the power path L2, is engaged in the dual-clutch transmission 1, while the reactive power no longer flows into the dual-clutch transmission 1, thus further increasing the efficiency factor eta of the dual-clutch transmission 1.

At a further point in time T7, there is in turn a request for a change of transmission ratio in the dual-clutch transmission 1, at which the third transmission ratio is to be engaged in the dual-clutch transmission 1. For this purpose, in turn through the dual-clutch device 4, a load transfer from the currently switched-on second sub-transmission 32 in the direction of the first sub-transmission 31 still switched-off at the point in time T7 is to be carried out by opening the second clutch K2 and simultaneously closing the first clutch K1. The load transfer carried out in the dual-clutch device 4 from the point in time T7 in turn leads to the fact that the turning moment m9 of the second transmission input shaft drops, while the turning moment m7 led through the first transmission input shaft 7 steadily increases. Due to the load transfer, the efficiency factor eta decreases at an increasing rate, and in turn reaches its minimum between a point in time T8 and a subsequent point in time T9. At the point in time T9, at which the rotational speed n2 of the transmission input shaft 2 corresponds to the rotational speed n2 of the first transmission input shaft 7, the clutch K1 is fully open, while the clutch K2 is fully closed. Thereby, the requested change of transmission ratio at the point in time T9 is essentially closed in the dual-clutch transmission 1, whereas the second transmission ratio is still engaged in the switched-off second sub-transmission 32.

Due to the second transmission ratio still engaged in the switched-off second sub-transmission 32, the dual-clutch transmission 1 is found in a similar operating state, which corresponds to the operating state of the dual-clutch transmission 1 described in FIG. 1, and at which the smaller second transmission ratio is engaged in the switched-off second sub-transmission 32, and the higher first transmission ratio is engaged in the switched-off first sub-transmission 31, and at which the reactive power flow LB flows through the switched-on first sub-transmission 32. At the operating state of the dual-clutch transmission 1 present at the point in time T9, the reactive power flow LB then flows counter to the turning moment to a large extent led through the switched-on first sub-transmission 31 between the transmission input shaft 2 and the transmission output shaft 3, and impairs the efficiency factor eta of the dual-clutch transmission 1 until a point in time T10, from which a fourth transmission ratio is engaged in the switched-off second sub-transmission 32, which is smaller than the third transmission ratio currently engaged in the switched-on first sub-transmission 31.

At the point in time T11, the fourth transmission ratio is fully engaged in the switched-off second sub-transmission 32, and the rotational speed n9 of the second transmission input shaft 9 features a rotational speed level equivalent to the synchronous speed of the fourth transmission ratio, while, due to the absence at that point of the reactive power flow in the switched-on first sub-transmission 31 from the point in time T11, the efficiency factor eta is greater than that at the point in time T10.

In contrast to conventional mode of operation of the dual-clutch transmission 1, described above and underlying FIG. 4, with which the first transmission ratio, the second transmission ratio or the third transmission ratio is engaged in the switched-off sub-transmission 31 or 32, and during which the power losses in the dual-clutch transmission 1, to a large extent impairing the efficiency factor eta, take effect, the sequences of the operating sizes of the dual-clutch transmission 1 presented in FIG. 5 arise if the dual-clutch transmission 1, in accordance with the approach under the invention once again more specifically described below, is operated between the points in time T1 and T10 for improving the efficiency factor eta of the dual-clutch transmission 1.

At the point in time T1, the first sub-transmission 31 is in turn switched on in the power flux of the dual-clutch transmission 1, while the second sub-transmission 32 in the dual-clutch device 4 is switched off from the power flux of the dual-clutch transmission 1. In the first sub-transmission, 31, the first transmission ratio is engaged, while the second transmission ratio is already engaged in the switched-off second sub-transmission 32. At the point in time T2, in accordance with the request, the process is commenced by which the first sub-transmission 31 is to be switched off from the power flux and the second sub-transmission 32 is to be switched on in the power flux of the dual-clutch transmission 1, which is why the turning moment m7 of the first transmission input shaft 7 decreases and the turning moment m9 of the second transmission input shaft 9 increases. Due to the load transfer, at the point in time T3, the rotational speed n2 of the transmission input shaft 2 decreases in the direction of the rotational speed n9 of the second transmission input shaft 9.

In addition, at the point in time T3, the double-shifting element 25 is transferred into its neutral position, and the first transmission ratio is disengaged in the first sub-transmission 31, which is why the rotational speed n7 of the first transmission input shaft 7 at the point in time T3, together with the rotational speed n2 of the transmission input shaft 2, is led in the direction of the rotational speed n9 of the second transmission input shaft 9, whereas the rotational speeds n2 and n7 at the point in time T4 correspond to the rotational speed n9. This results from the fact that, due to the drag moments arising in the clutch K1 fully open at the point in time T4, and due to the operating state decoupled from the transmission output shaft 3, the first transmission input shaft 7 is synchronized to the rotational speed n2 of the transmission input shaft 2.

In order to avoid, as much as possible, drag moments in the clutch K1 that impair the efficiency factor eta of the dual-clutch transmission 1, the transfer capacity of the first clutch K1, depending on the respective application, from the point in time from which all transmission ratios are disengaged in the sub-transmission 31, is increased to a value at which the clutch K1 is operated in a state that is slip-free. This approach does not change the sequence of the rotational speed n7 of the first transmission input shaft 7, presented in FIG. 5.

Based on the approach described above, the efficiency factor eta of the dual-clutch transmission 1 is reduced to its minimum until shortly after the point in time T3, and then substantially increases when compared to the approach underlying FIG. 4, whereby the dual-clutch transmission 1 is operated with a good efficiency factor within a short period of time.

After the completed change of transmission ratio in the dual-clutch transmission 1, starting from the first transmission ratio in the direction of the second transmission ratio, the double-shifting element 25 is actuated at the point in time T5 in the switched-off first sub-transmission 21, and the third transmission ratio is preliminarily engaged in the sub-transmission 31, which is still switched-off. This leads to the fact that the rotational speed n7, starting from the rotational speed n9 of the second transmission input shaft 9 in the direction of the synchronous speed of the third transmission ratio drops off, and reaches it at the point in time T6 at which the mode of operation of the dual-clutch transmission 1, which underlies FIG. 5, coincides with the point in time T7.

Due to the switching on of the third transmission ratio in the switched-off first sub-transmission 31, the turning moment m9 led through the second transmission input shaft 9 decreases, and the turning moment m7 led through the first transmission input shaft 7 increases, whereas the latter increase also corresponds to an increase in the power loss in the dual-clutch transmission 1, and has the consequence of the impairment of the efficiency factor eta.

At the point in time T6 or T7, as the case may be, at which the third transmission ratio is engaged in the switched-off first sub-transmission 31, a request for a change of transmission ratio, starting from the second transmission ratio in the direction of the third transmission ratio, commences, upon the carrying out of which in turn the second clutch K2 is open and the first clutch K1 is closed. This leads to the fact that the rotational speed n2 of the transmission input shaft 2 decreases from the point in time T8 in the direction of the rotational speed n7 of the first transmission input shaft 7, and the efficiency factor eta of the dual-clutch transmission 1 is impaired in the manner shown. At the same time, the second transmission ratio is disengaged in the second sub-transmission 32 by opening the double-shifting element 14, which is why the rotational speed n9 of the second transmission input shaft 9 is led in the direction of the rotational speed n7. At the point in time T9, the rotational speeds n2, n7, n9 are essentially commensurate, and the requested change of transmission ratio in the dual-clutch transmission 1, starting from the second transmission ratio in the direction of the third transmission ratio, is completed, whereas all transmission ratios are disengaged in the second sub-transmission 32, which is then switched off. Then, in the dual-clutch transmission 1, the power losses are in turn reduced to a minimum, which is why, shortly after the point in time T9, the efficiency factor eta reaches a level that the efficiency factor eta for the mode of operation of the dual-clutch transmission 1 underlying FIG. 4 reaches only very much later (if at all).

The approach underlying FIG. 5 enables a substantially more efficient and efficiency-optimized mode of operation of a dual-clutch transmission, with which, in a switched-off sub-transmission 31 or 32, all transmission ratios are disengaged preferably immediately after the transfer of the turning moment, and, under certain circumstances, the switched-off clutch K1 or K2 are even actuated to such an extent that the free transmission input shaft 7 or 9 of the dual-clutch transmission 1 is synchronized with the rotational speed of the transmission input shaft 2. The engagement of each requested next driving stage in the dual-clutch transmission 1 preferably takes place as chronologically coordinated as possible, such that, in each case, this is carried out only briefly prior to the fading of the turning moment.

Modifications and variations can be made to the embodiments illustrated or described herein without departing from the scope and spirit of the invention as set forth in the appended claims.

1-6. (canceled)

7. A method for operating a dual-clutch transmission having two sub-transmissions and a dual-clutch device, wherein the sub-transmission are able to be alternately switched-on or switched-off in the power flow of the dual-clutch transmission, and wherein each of the sub-transmissions has at least two different transmission ratios that are engaged or disengaged through actuation of shifting elements, the method comprising:
switching one of the sub-transmissions to a switched-on state and the other of the sub-transmissions to a switched-off state via actuation of the dual-clutch device, wherein one of the transmission ratios in the switched-on sub-transmission is engaged; and
disengaging all of the transmission ratios in the switched-off sub-transmission for at least as long as there is no request for a change of transmission ratio made on the dual-clutch transmission.

8. The method as in claim 7, wherein the dual-clutch device has a first clutch allocated to the switched-on sub-transmission and a second clutch allocated to the switched-off sub-transmission, wherein the second clutch allocated to the switched-off sub-transmission is fully open and has a transfer capacity equal to approximately zero such that one of the transmission ratios in the switched-off sub-transmission can be subsequently engaged in a load-free operating state.

9. The method as in claim 7, wherein the dual-clutch device has a first clutch allocated to the switched-on sub-transmission and a second clutch allocated to the switched-off sub-transmission, wherein the second clutch allocated to the switched-off sub-transmission is adjusted to a value so as to be operated in a slip-free state.

10. The method as in claim 7, wherein the dual-clutch device has a first clutch allocated to the switched-on sub-transmission and a second clutch allocated to the switched-off sub-transmission, and wherein for a request to carry out a change of transmission ratio from a first engaged transmission ratio in the switched-on sub-transmission to a target transmission ratio in the switched-off sub-transmission, the target transmission ratio is first engaged, and subsequently the switched-on sub-transmission is switched off by opening the first clutch and the switched-off sub-transmission is switched on by closing the second clutch.

11. The method as in claim 10, wherein the first engaged transmission ratio remains engaged after opening the first clutch until a probability for a further change back to the first engaged transmission ratio becomes less than threshold value.

12. The method as in claim 7, wherein the dual-clutch device has a first clutch allocated to the switched-on sub-transmission and a second clutch allocated to the switched-off sub-transmission, and wherein all of the transmission ratios in the switched-off sub-transmission are disengaged until there is a request for a further change of transmission ratio to a target transmission ration in the switched-off sub-transmission.
